(19) United States
(12) Patent Application Publication
(10) Pub. No.: US 2009/0065962 A1
(43) Pub. Date: Mar. 12, 2009

(54) Injection Device of an Injection Molding Machine and Method for the Operation Thereof

(75) Inventors: Thomas Budde, Wurzburg (DE); Ingo Geier, Cadolzburg (DE); Klaus Oberndorfer, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Munchen (DE)

(21) Appl. No.: 12/087,384

(22) PCT Filed: Dec. 22, 2006
(86) PCT No.: PCT/EP2006/070160

§ 371 Date: Jul. 3, 2008

(30) Foreign Application Priority Data
Jan. 9, 2006 (DE) 10 2006 001 346.8

(51) Int. Cl. B29C 45/77

(52) U.S. Cl. 264/40.3; 425/149

(57) ABSTRACT

There is described a device and a method for operating an injection device for an injection molding machine which is provided with an extruder screw that is driven by an electric machine. Acceleration values and/or values depending on an operating point of the electric machine are used for calculating an injection pressure and/or a ram pressure, thus dispensing with the need for a pressure sensor.

### CROSS REFERENCE TO RELATED APPLICATIONS

This application is the US National Stage of International Application No. PCT/EP2006/070160, filed Dec. 22, 2006 and claims the benefit thereof. The International Application claims the benefits of German application No. 10 2006 001 346.8 DE filed Jan. 9, 2006, both of the applications are incorporated by reference herein in their entirety.

### FIELD OF INVENTION

The invention relates to a method for operating an injection device of an injection molding machine and to a corresponding injection device. The injection molding machine has an injection device, said injection device comprising an extruder screw drivable by means of an electrical machine, a screw cylinder and a heater.

### BACKGROUND OF INVENTION

A typical injection sequence will now be described. In an injection molding process, plastic granulate is fed via a fill hopper to a screw which is also known as an extruder screw. Rotary motion of the screw causes the plastic granulate to be conveyed forward in the direction of the tip of the screw. As the plastic granulate, which changes into a molten mass, is transferred forward to the tip of the screw, the screw retreats by approximately the same amount, i.e. back in the opposite direction. The plastic granulate is caused to melt by the heat dissipated as a result of the conveying and by means of the electric heater which is provided on a screw cylinder. A plastic granulate melt accumulates ahead of the screw tip in a so-called screw antechamber and forces the screw back. As e.g. the shear heat generated depends on the pressure exerted by the screw on the material, this pressure can be specified as a pressure/displacement profile and controlled on a closed- or open-loop basis. If sufficient molten material has been metered into the screw antechamber, the screw is forced forward as a kind of piston, i.e. in the direction of the screw tip, thus enabling the plastic granulate melt to be injected into a closed mold. The closed mold is a tool consisting e.g. of two mold sections.

### SUMMARY OF INVENTION

The velocity of the screw, particularly when acting as a piston, is closed-loop controlled such that the pressure does not fall below a specified limit. The limit pressure relates e.g. to the pressure in front of the screw tip. If the tool is filled with the molten plastic granulate, i.e. the plastic melt, the pressure in the tool increases rapidly, as compression of the molten material (plastic melt) now occurs. In this phase, control is switched from screw velocity control to pressure control, it being of great importance here that such a switch is executed reproducibly and precisely. A switching criterion is used for the changeover. The switching criterion is a criterion for the transition between two types of closed-loop control, one type being e.g. velocity control and a second type being pressure control.

Open-loop velocity control can also be used instead of closed-loop velocity control. Likewise open-loop pressure control can also be employed instead of close-loop pressure control. The transition criterion then consequently relates to two open-loop control types.

The switching criterion is e.g. the position of the screw, a melt pressure or an internal mold pressure inside the tool. The switch constitutes a changeover from e.g. closed-loop velocity control to closed-loop pressure control. Pressure dips or pressure peaks which are detrimental to the quality of the injection molded parts must be prevented from occurring. In order to constantly achieve a reproducible and highly precise changeover to pressure control particularly in respect of a switching criterion, e.g. maximally short sampling times for the closed- and/or open-loop control can be used. A possible sampling time is e.g. in the order of 100 μs.

When the tool is now filled with injected material, the cooling of the material causes the material to shrink. This shrinkage is advantageously compensated by the piston continuing to force material into the tool after the injection process via a pressure-time profile. For this purpose and all such pressure control or monitoring tasks it has hitherto been imperative to measure the actual pressure, i.e. the injection pressure or the dynamic pressure, the injection pressure being the pressure during the injection process and the dynamic pressure the pressure to be maintained after the injection process.

The dynamic pressure and/or injection pressure are generally measured by pressure sensors. These can be sensors which directly measure the melt pressure in the screw antechamber or even strain gages or more specifically load cells which measure the bearing forces resulting from the dynamic pressure at a suitable place in the mechanism. Both methods involve high costs.

An object of the present invention is now to specify a method for operating an injection device of an injection molding machine or an injection device itself, whereby it is possible to eliminate hitherto necessary pressure sensors or corresponding measuring devices for determining the injection pressure or the dynamic pressure.

This object is achieved by means of a method having the features set forth in an independent claim. The method can be inventively used for an injection molding machine or for an injection device for same. The sub-claims are advantageous inventive developments of the method. Another solution will emerge for an injection device for an injection molding machine having the features set forth in a further independent claim. The dependent sub-claims show advantageous developments of the device.

In a method for operating an injection device for an injection molding machine, said device having an extruder screw that can be driven by means of an electrical machine, acceleration values and/or values dependent on an operating point of the electrical machine are used to calculate an injection pressure and/or a dynamic pressure.

As the injection device has an extruder screw that can be driven by means of an electrical machine, values of the electrical machine can be used for calculating the injection pressure or the dynamic pressure. The advantage of this is that a sensor can be dispensed with for this purpose. For the calculation, not only a torque generating current of the electrical machine is used as a calculation value, but also other values which are a function of an acceleration value and/or of an operating point of the electrical machine.

The acceleration value is e.g. a derivative of the speed of the electrical machine or of the screw with respect to time or also a linear acceleration of the screw in the direction of the tool (mold). By including the acceleration value, acceleration forces occurring are jointly taken into account for calculating the injection pressure or dynamic pressure. The allowance for the acceleration forces when calculating the dynamic or injection pressure is based on the fundamental dynamic principle according to which the sum of all forces including the forces of inertia is constantly in equilibrium.

The inclusion of the operating point dependent values of the electrical machine means that operating point dependent ratios of the electric current to the resulting torque are also taken into account in the pressure calculation.

In an advantageous embodiment of the method, a description value of the electrical machine is a torque constant, said torque constant of the electrical machine being a value dependent on the operating point of the electrical machine and jointly used in an operating point dependent manner to calculate the injection pressure and/or the dynamic pressure.

It will now be shown how acceleration values and/or operating point dependent torque constants can be used to calculate the dynamic pressure or the injection pressure.

In the calculation:
Mₚᵣₑₛₛ=dynamic pressure or injection pressure generating torque
M_{acc}=force of inertia
Mₘₒₜ=motor torque (of the electrical machine)
q=efficiency of the spindle (and/or of the extruder screw)
J=resulting total mass moment of inertia from motor, screw and spindle
Kt=torque constant (Kt value)
I=torque generating current
n=speed (rpm)
P=spindle pitch
F_{S}=shear force
P_{screw}=dynamic pressure or injection pressure
R_{screw}=screw radius
where:

I) Mₚᵣₑₛₛ=(Mₘₒₜ−M_{acc})*η

II) Mₘₒₜ=Kt*I

III) M_{acc}=J*dn/dt

This yields the dynamic pressure or injection pressure generating torque:

II and III in I: Mₚᵣₑₛₛ=(Kt*I−J*dn/dt)*η

Via the spindle pitch, the force applied to the screw and therefrom, via the screw diameter, the resulting pressure can now be calculated.

Fₛ=Mₚᵣₑₛₛ*2n/p

P_{screw}=Fs/(R_{screw}*η)

The operating point dependence of the Kt factor is advantageously taken into account. For this purpose, for example, the electrical machine is calibrated and the Kt factors stored. This typically takes place in the electrical machine production plant. The Kt factors are advantageously stored in a storage device on the electrical machine, the stored values being readable by a closed-loop and/or open-loop control device. The closed-loop and/or open-loop control device is designed e.g. for controlling the speed and/or current of the electrical machine. The storage device is e.g. a motor electronic circuit or even an electronic circuit of an encoder for the electrical machine provided as the motor for the extruder screw.

The torque constant KT typically varies both via the speed (rpm) and via the load torque. The torque constant also varies from electrical machine to electrical machine depending on manufacture. By individually detecting the relevant characteristics for a particular electrical machine, the KT can be determined as a function of the current and speed currently obtaining. This enables e.g. machine parameters to be transferred from one machine to another.

By way of example, a table with different Kt values for different operating points is shown below. The number of operating points incorporated is selectable, it being possible not only to draw up a table, but also to create a function of the operating point dependent values. An interpolation function, for example, can be used for this purpose.

| | n | M | I | U1 | Kt |
|---|---|---|---|---|---|
| Operating points | min⁻¹ | Nm | A | V | Nm/A |
| 1 | 100 | 224.30 | 107.60 | 26.70 | 2.08 |
| 2 | 500 | 220.00 | 107.60 | 87.60 | 2.04 |
| 3 | 1000 | 217.80 | 107.60 | 165.00 | 2.02 |
| 4 | 1500 | 216.60 | 107.70 | 240.00 | 2.01 |
| 5 | 2000 | 215.80 | 107.60 | 314.00 | 2.01 |

In another advantageous embodiment of the method, different values of the temperature dependent torque constant as a function of a temperature are used for calculating the injection pressure and/or dynamic pressure. By allowing for the temperature dependence of the Kt factor, i.e. the Kt value, the accuracy of the pressure calculation can be increased. Thus the dependence of the KT factor on the temperature of the magnetic material in the case of an electrical machine implemented as a permanent magnet excited electrical machine can additionally be compensated by measuring the motor temperature. When using commercially available neodymium-iron-boron permanent magnets, the decrease in the magnetization is typically 12% for 100 K heating of a rotor of the electrical machine.

The operating point dependent value used in the pressure calculation can be read out of a memory or also estimated. The estimation is performed in a so-called Kt estimator, currently detected EMF values being used for the estimation.

The method can also be advantageously embodied such that a friction characteristic of the extruder screw can be jointly used for calculating the injection pressure and/or the dynamic pressure. Such an allowance for the rpm dependence of the spindle friction also allows the pressure to be calculated more precisely. For this purpose the friction characteristic of the spindle is advantageously recorded e.g. by means of an automation system and subsequently taken into account for axle control or pressure calculation.

In another advantageous embodiment of the method, the injection pressure and/or dynamic pressure is calculated using a closed-loop and/or open-loop control device incorporating the current regulator and/or speed regulator of the electrical machine. This enables dead times which would arise from using a separate closed-loop and/or open-loop control device to be reduced. This also applies to the case where not only pressure calculation takes place in the closed-loop and/or open-loop control device in which the current regulator and/or speed regulator of the electrical machine are incorporated, but also other open-loop and/or closed-loop control functions of the injection device or the injection molding machine.

If the closed-loop and/or open-loop control device for the current or speed regulator of the drive has sufficient computing capability, both a torque calculation and/or a pressure calculation can be performed beforehand on a subordinate basis. This confers further advantages in terms of controller design, as then e.g. filtering of the values can be carried out beforehand in the subordinate regulator.

An injection device particularly for an injection molding machine has a closed-loop and/or open-loop control device. Operating point dependent values of a torque constant of an electrical machine can be stored in a memory, said operating point dependent values being provided in particular for calculating an injection pressure and/or a dynamic pressure. An inventive method can be carried out by means of such an injection device.

In the injection device, the calculated injection pressure and/or dynamic pressure is intended to replace an actual injection pressure and/or dynamic pressure value obtainable by means of a pressure measuring device, the injection molding machine in particular being designed without such a pressure measuring device.

The injection device is e.g. designed such that the injection device has an extruder screw drivable by means of an electrical machine, an encoder being provided for detecting the speed of the electrical machine, and actual speed values being provided for calculating the injection pressure and/or dynamic pressure.

### BRIEF DESCRIPTION OF THE DRAWINGS

Exemplary embodiments of the invention which will be described in greater detail below are shown in the accompanying drawings in which:

FIG. 1 shows the phases of an injection process,

FIG. 2 shows a belt drive device providing linear motion,

FIG. 3 shows drive devices,

FIG. 4 shows the use of a Kt estimator and

FIG. 5 shows a friction characteristic.

### DETAILED DESCRIPTION OF INVENTION

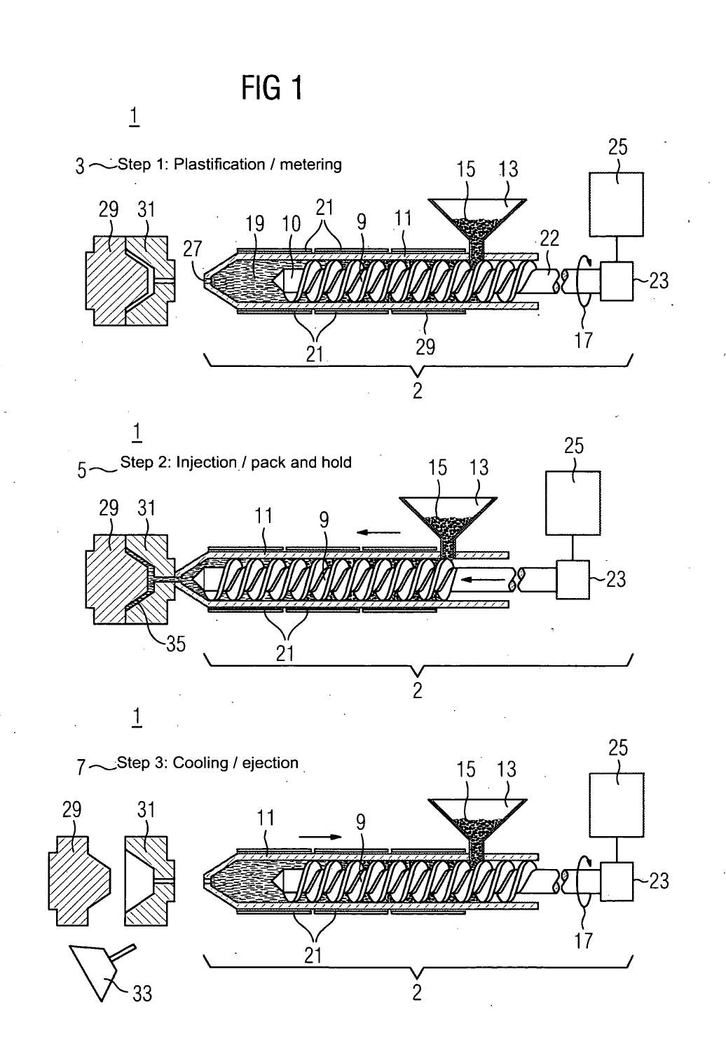

The drawing in FIG. 1 shows three steps 3, 5, 7 of an injection molding process (molding process) for an injection molding machine 1, illustrated in rudimentary fashion only, which has an injection device 2. The first step 3 relates to plasticization and metering, the second step 5 relates to injection and pack/hold and the third step 7 relates to cooling and ejection. The molding process relates to an injection molding machine 1. The injection molding machine 1 has a screw 9. The screw 9 is located in a screw cylinder 11. The injection molding machine 1 also has a hopper 13. The hopper 13 can be filled with plastic granulate 15. The plastic granulate 15 is to be transported into a screw antechamber by rotary motion 17 of the screw 9. During transportation, the plastic granulate is heated by friction or by means of an electric heater 21 to produce a melt. Rotary motion 17 causes the melt to accumulate in the screw antechamber 19 in front of the screw tip 10. The rotary motion 17 can be achieved e.g. by means of an electrical machine 23. The electrical machine 21 is coupled to an axle 22 and controllable e.g. by means of a closed-loop and/or open-loop control device 25. The build-up of melt in the screw antechamber 19 causes the screw 9 to be pushed away from a nozzle 27. The nozzle 27 is designed to discharge the melt. The nozzle 27 can be guided to a tool 29, 31. The tool 29, 31 has two sections. The first section 29 and the second section 31 are joined together to form a mold. The first step 3 of the molding process includes plasticization and metering of the molten material. The second step 5 of the molding process relates to the injection of the melt or the packing/holding thereof. To inject the melt, the screw 9 is moved in the direction of the nozzle 27, causing melt to be forced into the tool 29, 31. At the end of injection, pack/hold pressure is applied.

In a third step 7 of the molding process, cooling and ejection take place. The screw cylinder 11 is separated from the tool 31. The two parts of the tool 29 and 31 are separated so that an injected molded article 33 is released. After this step, the first step 3 of the molding process is repeated, namely plastification and metering.

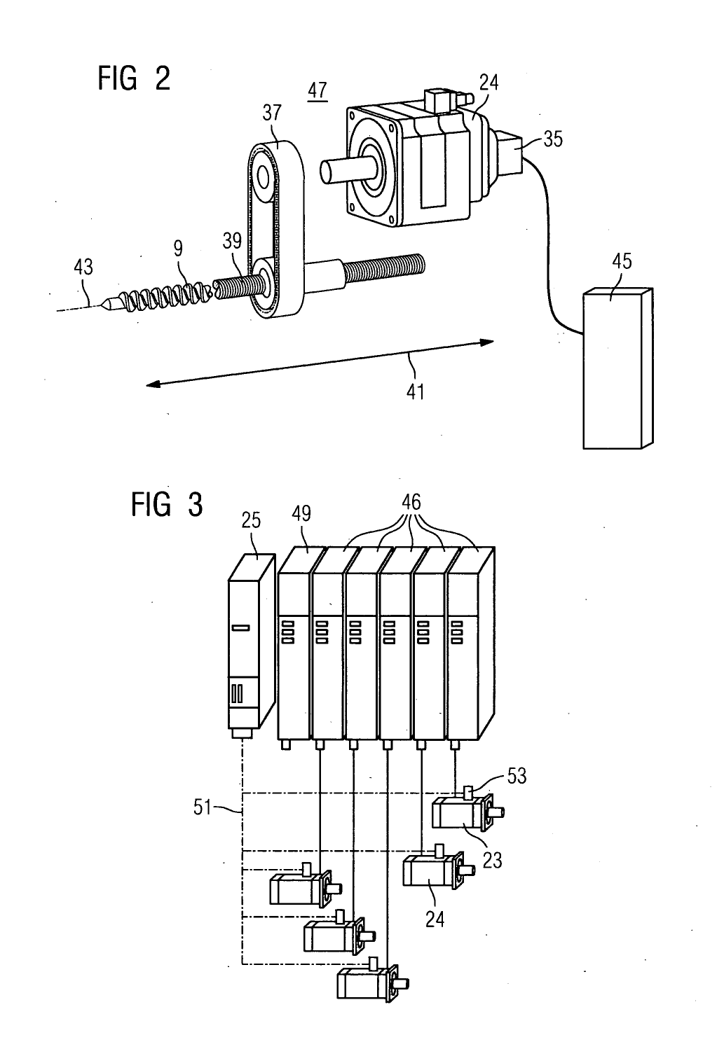

The drawing in FIG. 2 shows a belt drive device 47. The rotary motion of an electrical machine 24 having an encoder 35 can be transmitted by means of a belt 37. The electrical machine 24 is connected to a drive device 45, said drive device 45 comprising e.g. a power converter and a closed-loop and/or open-loop control device. The rotary motion can be converted to linear motion 41 by means of a spindle 39. The linear motion 41 produces linear movement of the screw 9 which is advantageously located in the same axle 43 as the spindle 39. The electrical machine 24 can be a different machine from the electrical machine 23 from FIG. 1, if the rotary motion of the screw 9 and the linear motion of the screw 9 are to be implemented by different electrical machines. The direction of rotation and the linear motion of the screw can also be implemented by just a single electrical machine so that in this case the electrical machines 23 and 24 are identical.

The drawing in FIG. 3 shows a design incorporating different drive devices 46. The drive devices 46 are each assigned to an electrical machine 23, 24 and connected thereto. The drive devices 46 are fed by a common feeding device 49. The drive devices 46 are embodied such that they are connected to a common closed-loop and/or open-loop control device 25. In said closed-loop and/or open-loop control device 25, in particular speed control of the connected drive devices 46 is performed. This function can also be incorporated in the drive device, although this is not shown in FIG. 3. The open-loop and/or closed-loop control device 25 can optionally be connected to the electrical machines 23, 24 via a drive bus system 51. The electrical machines 23, 24 have an encoder interface with an electronic rating plate 53 where e.g. Kt values for the respective electrical machine 23, 24 are stored.

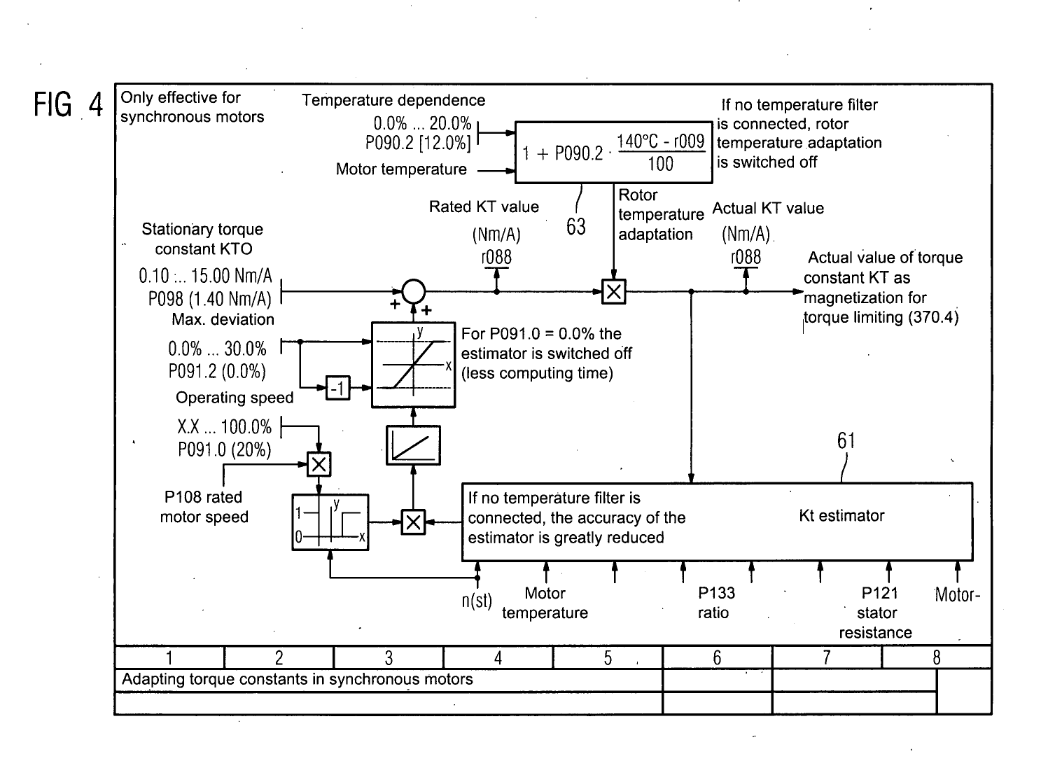

FIG. 4 shows an example of adapting the torque constants for synchronous machines using a Kt estimator 61. Temperature adaptation 63 is also provided.

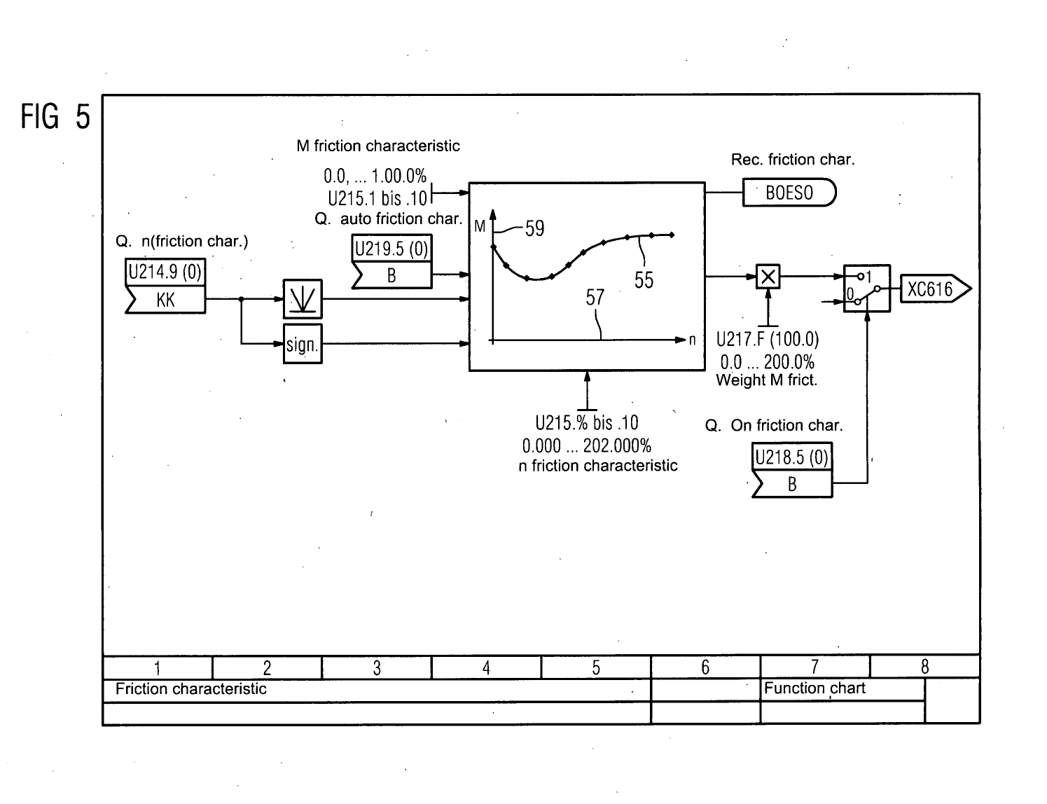

FIG. 5 shows an example of using a friction characteristic 55, wherein a torque 59 is plotted against a speed 57.

1-10. (canceled)

11. A method for operating an injection device for an injection molding machine, comprising:
providing an extruder screw driven based upon an electrical machine;
calculating a pressure based upon acceleration values and/or values dependent on an operating point of the electrical machine.

12. The method as claimed in claim 11, wherein the pressure is an injection pressure.

13. The method as claimed in claim 11, wherein the pressure is a dynamic pressure.

14. The method as claimed in claim 11, wherein a description value of the electrical machine is a torque constant dependent on the operating point of the electrical machine, wherein the torque constant is used for calculating the injection pressure on an operating point dependent basis.

15. The method as claimed in claim 11, wherein a description value of the electrical machine is a torque constant dependent on the operating point of the electrical machine, wherein the torque constant is used for calculating the dynamic pressure on an operating point dependent basis.

16. The method as claimed in claim 14, wherein different values of the temperature-dependent torque constant as a function of a temperature are used.

17. The method as claimed in claim 15, wherein different values of the temperature-dependent torque constant as a function of a temperature are used.

18. The method as claimed in claim 11, wherein the temperature-dependent value is read out from a memory.

19. The method as claimed in claim 11, wherein the temperature-dependent value is estimated.

20. The method as claimed in 11, wherein a friction characteristic of the extruder screw is used for calculating a injection pressure.

21. The method as claimed in 11, wherein a friction characteristic of the extruder screw is used for calculating a dynamic pressure.

22. The method as claimed in claim 11, wherein a control device, in which the current regulator and the speed regulator of the electrical machine are incorporated, is used for calculating the pressure.

23. An injection device, comprising:
a closed-loop control device;
operating point dependent values of a torque constant of an electrical machine stored in a memory; and
a calculated injection pressure, calculated based upon the operating point dependent values, wherein the calculated injection pressure replaces a measurement of an actual injection pressure value, wherein a injection molding machine having the injection device lacks a pressure measuring device.

24. An injection device, comprising:
a closed-loop control device;
operating point dependent values of a torque constant of an electrical machine stored in a memory, the operating point dependent values being used in particular for calculating an injection pressure and a dynamic pressure.

25. The injection device as claimed in claim 24, wherein the calculated injection pressure and dynamic pressure replace an actual injection pressure and dynamic pressure value determined via a pressure measuring device.

26. The injection device as claimed in claim 24, wherein the injection device has an extruder screw, an electrical machine, and an encoder to detect a speed of the electrical machine, and wherein actual speed values are provided to calculate the injection pressure and/or the dynamic pressure.

27. The injection device as claimed in claim 25, wherein the injection device has an extruder screw, an electrical machine, and an encoder to detect a speed of the electrical machine, and wherein actual speed values are provided to calculate the injection pressure and/or the dynamic pressure.
